(19) United States
(12) Patent Application Publication
(10) Pub. No.: US 2009/0100514 A1
(43) Pub. Date: Apr. 16, 2009

(54) METHOD FOR MOBILE NODE'S CONNECTION TO VIRTUAL PRIVATE NETWORK USING MOBILE IP

(76) Inventors: Sung-Il Jin, Seoul (KR); Nak-Po Kim, Seoul (KR); Ki-Jin Baek, Gyeonggi-do (KR)

Correspondence Address: JONES DAY, 222 EAST 41ST ST, NEW YORK, NY, 10017, US

(21) Appl. No.: 11/910,001

(22) PCT Filed: Mar. 21, 2006
(86) PCT No.: PCT/KR2006/001033

§ 371 Date: Apr. 29, 2008

(30) Foreign Application Priority Data
Mar. 28, 2005 (KR) 10-2005-0025530

(51) Int. Cl. G06F 17/00

(52) U.S. Cl. 726/15

(57) ABSTRACT

A method for a mobile node's connection to a virtual private network using a mobile IP under a mobile environment is provided. According to this method, the mobile node firstly makes a mobile IP registration request message including VPN user authentication information and transmits the message to VPN gateway. Then, the VPN gateway reads the VPN user authentication information from the message and inquires a database in which VPN user authentication information is already stored, to verify a VPN access authority of the mobile node. If the access authority is verified, private IP is recorded in a response message to the mobile IP registration request message, and the response message is transmitted to the mobile node to assign the private IP. Accordingly, a VPN having low construction cost, simple topology, less network traffic and low working loads on the mobile node and the network under a mobile environment can be constructed.

### TECHNICAL FIELD

The present invention relates to a connection to a virtual private network, and more particularly to a method for connection to a virtual private network using a mobile IP under a mobile environment.

### BACKGROUND ART

A virtual private network is defined as a technique or a communication network, which allows to construct a private network using a public network such as Internet. According to a common virtual private network connection method, an IP address is assigned to a terminal from a foreign network, user authentication is performed by a VPN gateway, then a private IP address is assigned, and then data packets are transmitted or received using the tunneling technique.

Meanwhile, in case a terminal accessing a virtual private network is a mobile node (e.g., a mobile phone, a notebook or PDA) that should guarantee mobility, it is generally considered to adopt a mobile IP suggested in IETF. If the mobile IP is adopted, data service can be provided though a connection point is changed due to movement, not requiring a user to have a fixed connection point for service. In the mobile IP, the mobile node is assigned with two IP addresses so as to guarantee mobility. One is a fixed ‘home IP address’ and the other is an ‘after-movement IP address’ acquired when the mobile node moves from a home network to a foreign network.

Here, the after-movement IP address can be any of COA (Care Of Address) acquired from an agent advertisement message of FA (Foreign Agent) that is a router of the foreign network, and CCOA (Co-located Care Of Address) manually set by the mobile node temporarily among IP addresses belonging to the foreign network or acquired through PPP/DHCP server.

The home IP address and the after-movement IP address of the mobile node are used for data packets routing, conducted between a mobile node and a correspondent node of an opponent (a correspondent node communicating with the mobile node, for example a server). Thus, HA (Home Agent) was essentially needed in the prior art so as to register and manage binding information of the home IP address and the after-movement IP address of the mobile node.

Here, the HA is a kind of router, and it continuously updates and manages the binding information by receiving a mobile IP registration request message from a mobile node whenever the network is changed.

In addition, in order to access a virtual private network using a mobile node under a mobile IP environment, two processes for being assigned with a mobile IP from HA or FA, and then assigned again with a private IP through VPN user authentication in connection to a virtual private network gateway should be previously executed. As described above, in order that a mobile node requiring guarantee of mobility accesses a virtual private network, a separate equipment HA for mobile IP should be considered together with the virtual private network gateway. In addition, the mobile IP assigning process and the private IP assigning process should be executed independently.

Accordingly, there arise many problems such that complexity of the network topology and the access process increases, and high cost is required due to the independent operation of HA and a virtual private network gateway. Furthermore, all programs for accessing a virtual private network and for assigning a mobile IP should be installed in a mobile node, which impose working loads on a system of the mobile node.

### DISCLOSURE OF INVENTION

### Technical Problem

The present invention is designed in consideration of the above problems, and therefore it is an object of the invention to provide a method for connection to a virtual private network, which may construct a network for connection to a virtual private network at a low cost by using a mobile IP, without imposing working loads on a mobile node.

### Technical Solution

In order to accomplish the above object, the present invention provides a method for a mobile node's connection to a virtual private network using a mobile IP (Internet Protocol), which includes (a) the mobile node making a mobile IP registration request message including VPN (Virtual Private Network) user authentication information and transmitting the message to a virtual private network gateway; (b) the virtual private network gateway reading out the VPN user authentication information from the mobile IP registration request message and inquiring a database in which VPN user authentication information is already stored, so as to verify a virtual private network access authority of the mobile node; and (c) if the access authority is verified, recording a private IP in a response message to the mobile IP registration request message and transmitting the response message to the mobile node so as to assign the private IP.

Preferably, the VPN user authentication information includes user identification information and mobile node identification information, and, in the step (b), for the access authority verification, sameness among the VPN user authentication information, the user identification information and the mobile node identification information recorded in the database is verified.

For example, the user identification information is NAI (Network Access Indicator), and the mobile node identification information is a code obtained by encoding a random number using ESN (Electronic Serial Number) as a key. In this case, the database stores NAI and ESN of the mobile node, and the VPN user authentication information further includes a random number.

Then, the step (b) is executed including (b1) the virtual private network gateway making a VPN user authentication request message including NAI, the random number and the encoded code and transmitting the message to AAA (Authentication, Authorization, Accounting) possessing the database; (b2) the AAA inquiring the database to check registration for the NAI; (b3) the AAA checking whether an encoded result of the random number using ESN registered in the database as a key is identical to the encoded code transmitted from the virtual private network gateway; and (b4) the AAA transmitting a VPN user authentication result to the virtual private network gateway according to a result of the checking step.

As an alternative, the step (b) includes (b1) the virtual private network gateway inquiring the database to check registration for the NAI included in the VPN user authentication information; (b2) the virtual private network gateway checking whether an encoded result of the random number using ESN registered in the database as a key is identical to the encoded code included in the VPN user authentication information; and (b3) the virtual private network gateway checking whether the mobile node has a virtual private network access authority according to a result of the checking step.

According to the present invention, the mobile IP registration request message could include a home IP address and an after-movement IP address of the mobile node. In addition, the method could further include a step of: the virtual private network gateway registering binding information of the home IP address and the after-movement IP address of the mobile node.

Here, the after-movement IP address could be CCOA (Co-located Care Of Address). As an alternative, the after-movement IP address could be COA (Care Of Address) obtained from FA (Foreign Agent) by the mobile node, and in this case, the mobile IP registration request message is transmitted to the virtual private network gateway by means of the FA.

Preferably, the private IP address is recorded in a home IP address field of the response message.

### BRIEF DESCRIPTION OF THE DRAWINGS

These and other features, aspects, and advantages of preferred embodiments of the present invention will be more fully described in the following detailed description, taken accompanying drawing. In the drawing:

FIG. 1 is a flowchart illustrating a method for connection to a virtual private network using a mobile IP according to an embodiment of the present invention.

### BEST MODE FOR CARRYING OUT THE INVENTION

Hereinafter, preferred embodiments of the present invention will be described in detail with reference to the accompanying drawing. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

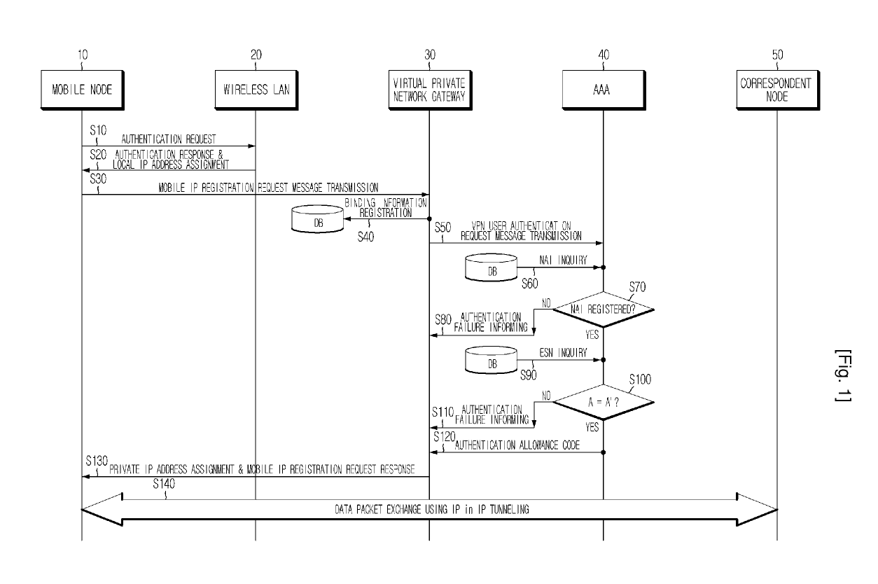

FIG. 1 is a flowchart illustrating a method for connection to a virtual private network using a mobile IP according to an embodiment of the present invention. In FIG. 1, reference numeral 10 indicates a mobile node, 20 indicates a wireless LAN, 30 indicates a virtual private network gateway, 40 indicates AAA (Authentication, Authorization, Accounting) and 50 indicates a correspondent node, respectively.

The mobile node 10 is assumed to be moved from a home network to a foreign network, and it includes a home IP address and an after-movement address together. Preferably, the after-movement address is CCOA.

As shown in FIG. 1, the mobile node 10 firstly requests authentication to the wireless LAN 20, and then stands by its response (S10). Then, the wireless LAN 20 authenticates the mobile node 10 and then assigns a local IP (S20).

Subsequently, the mobile node 10 makes a mobile IP registration request message and then directly transmits it to the virtual private network gateway 30 (S30). The mobile IP registration request message is made for two purposes, namely VPN user authentication and registration of the binding information for the home IP address and CCOA of the mobile node.

The mobile IP registration request message is made according to RFC standards, and it further includes information for VPN user authentication in its extension field. The user authentication information is used for verifying a virtual private network access authority of the mobile node 10, and it includes user identification information and mobile node identification information.

Preferably, the VPN user authentication information includes at least a code encoded by NAI (Network Access Indicator) and ESN (Electronic Serial Number). More specifically, the authentication information includes IMSI (International Mobile Station/Subscriber Identity) as information corresponding to NAI, and also includes following codes A and B. As a reference, in a formula for calculating the code A, MD5 is an encoding algorithm, and A is calculated using MD5 according to RADIUS standards and mobile IP authentication of RFC standards.

A=MD5 (B's 1 byte∥Key∥Md.5 (Proceeding Mobile IP data∥Type, Subtype (if present), Length, SPI)∥B), Key=ESN

B=Random Value (4 Bytes)

The above IMSI, A and B are respectively stored in NAI Extension, MN-AAA Extension and MN-FA Challenge Extension of the mobile IP registration request message, and transmitted to the virtual private network gateway 30.

Meanwhile, though not shown in the drawing, as an alternative embodiment, the mobile node 10 could have a COA address advertised by FA as an after-movement address. In this case, the mobile node 10 transmits the mobile IP registration request message to FA, and FA transmits the mobile IP registration request message to the virtual private network gateway 30 by means of relay operation.

If the mobile IP registration request message is transmitted in the step S30, the virtual private network gateway 30 registers the binding information in a database (S40). It makes the virtual private network gateway 30 act as HA. Furthermore, the virtual private network gateway 30 makes a VPN user authentication request message and transmits it to AAA 40 (S50).

The VPN user authentication request message includes parameters such as User Name, CHAP-PASSWORD and Chap-Challenge, and the following code is stored in each parameter.
User Name=NAI (IMSI)
CHAP-PASSWORD=B′ 1 byte+A
Chap-Challenge=MD5 (Preceding MIP RRQ, Type, Subtype, Length, SPI)∥B

If the VPN user authentication request message is transmitted in the step S50, the AAA 40 inquires NAI (IMSI) in the database storing NAI (IMSI) and ESN for each virtual private network subscriber (S60). Preferably, the database is built when a mobile node subscribes to the virtual private network access service implemented by the present invention.

If it is determined that NAI (IMSI) included in the VPN user authentication request message is not registered in the database as a result of the inquiry of the step S60 (NO of S70), the AAA 40 informs the virtual private network gateway 30 that the VPN user authentication is failed (S80). Then, the virtual private network gateway 30 considers that the mobile node has no authority for accessing the virtual private network, and then does not assign a private IP to the mobile node 10.

On the contrary, if NAI (IMSI) is registered in the database (YES of S70), the AAA 40 reads out the stored ESN matched with NAI (IMSI) (S90). And then, it is determined whether A extracted from CHAP-PASSWORD included in the VPN user authentication request message is same as A′ calculated by the following formula (S100).

A′=MD5(B′1 byte∥Key (=ESN)∥Chap-Challenge)

As a result, if there is no sameness (NO of S100), the AAA 40 informs the virtual private network gateway 30 that the VPN user authentication is failed (S110). Then, the virtual private network gateway 30 considers that the mobile node 10 has no authority for accessing the virtual private network, and then does not assign a private IP address to the mobile node 10. Accordingly, the mobile node 10 cannot access the virtual private network.

On the contrary, if there is sameness (YES of S100), the AAA 40 transmits a VPN user authentication allowance code to the virtual private network gateway 30 (S120). Then, the virtual private network gateway 30 considers that the mobile node 10 has an authority for accessing the virtual private network, and then the virtual private network gateway 30 assigns an establishable private IP address to the mobile node 10, then makes a response message to the mobile IP registration request and transmits it to the mobile node 10 (S130). And then, the virtual private network gateway 30 allows the mobile node to access the virtual private network.

The response message is made according to RFC standards, and the private IP address is preferably recorded in a home IP address region of the response message.

In the step S130, if the response message is transmitted, the virtual private network gateway 30 and the mobile node 10 are connected. In addition, the mobile node 10 can exchange data packets with the correspondent node 50 included in the virtual private network under a mobile environment by means of IP in IP tunneling (or, reverse tunneling) (S140). Here, the IP in IP tunneling follows the standards described in RFC 2003[15].

Meanwhile, in the above embodiment, the VPN user authentication process is conducted by interaction of the virtual private network gateway 30 and the AAA 40. However, on occasions, the virtual private network gateway 30 may solely construct a database and directly conduct the VPN user authentication process, which was conducted by the AAA 40.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to the present invention, it is possible to realize virtual private network access service under a mobile environment without consuming much cost, since HA is not separately operated.

In addition, since the virtual private network gateway conducts even a function of HA in complex, the network topology can be simplified.

Furthermore, since the binding information registration process of a home IP address and an after-movement IP address of a mobile node and the VPN user authentication process are integrated, traffic can be reduced as much.

In addition, a dedicated program for accessing a virtual private network and a dedicated program for realizing mobile IP can be integrally operated as one program in a mobile node, not loaded separately, so working loads imposed on the mobile node can be reduced.

The present invention allows implementation of virtual private network access service under a mobile environment without any special change of a network and a mobile node in case the mobile IP is evolved to an essential shape in the future. In addition, the mobile IP can be utilized as a private IP of the VPN environment though its mobility may not be guaranteed.

1. A method for a mobile node's connection to a virtual private network using a mobile IP (Internet Protocol), comprising:
(a) the mobile node making a mobile IP registration request message including VPN (Virtual Private Network) user authentication information and transmitting the message to a virtual private network gateway;
(b) the virtual private network gateway reading out the VPN user authentication information from the mobile IP registration request message and inquiring a database in which VPN user authentication information is already stored, so as to verify a virtual private network access authority of the mobile node; and
(c) if the access authority is verified, recording a private IP in a response message to the mobile IP registration request message and transmitting the response message to the mobile node so as to assign the private IP.

2. The method for a mobile node's connection to a virtual private network using a mobile IP according to claim 1,
wherein the VPN user authentication information includes user identification information and mobile node identification information, and
wherein, in the step (b), for the access authority verification, sameness between the VPN user authentication information and the user identification information and the mobile node identification information recorded in the database is verified.

3. The method for a mobile node's connection to a virtual private network using a mobile IP according to claim 2,
wherein the user identification information is NAI (Network Access Indicator), and the mobile node identification information is a code obtained by encoding a random number using ESN (Electronic Serial Number) as a key.

4. The method for a mobile node's connection to a virtual private network using a mobile IP according to claim 3,
wherein the database stores NAI and ESN of the mobile node, wherein the VPN user authentication information further includes a random number, and
wherein the step (b) includes:
(b1) the virtual private network gateway making a VPN user authentication request message including NAI, the random number and the encoded code and transmitting the message to AAA (Authentication, Authorization, Accounting) possessing the database;
(b2) the AAA inquiring the database to check registration for the NAI;
(b3) the AAA checking whether an encoded result of the random number using ESN registered in the database as a key is identical to the encoded code transmitted from the virtual private network gateway; and
(b4) the AAA transmitting a VPN user authentication result to the virtual private network gateway according to a result of the checking step.

5. The method for a mobile node's connection to a virtual private network using a mobile IP according to claim 3,
wherein the database stores NAI and ESN of the mobile node, wherein the VPN user authentication information further includes a random number, and
wherein the step (b) includes:
(b1) the virtual private network gateway inquiring the database to check registration for the NAI included in the VPN user authentication information;
(b2) the virtual private network gateway checking whether an encoded result of the random number using ESN registered in the database as a key is identical to the encoded code included in the VPN user authentication information; and
(b3) the virtual private network gateway checking whether the mobile node has a virtual private network access authority according to a result of the checking step.

6. The method for a mobile node's connection to a virtual private network using a mobile IP according to claim 1,
wherein the mobile IP registration request message includes a home IP address and an after-movement IP address of the mobile node, and
wherein the method further comprises a step of:
the virtual private network gateway registering binding information of the home IP address and the after-movement IP address of the mobile node.

7. The method for a mobile node's connection to a virtual private network using a mobile IP according to claim 1,
wherein the after-movement IP address is CCOA (Co-located Care Of Address).

8. The method for a mobile node's connection to a virtual private network using a mobile IP according to claim 1,
wherein the after-movement IP address is COA (Care Of Address) obtained from FA (Foreign Agent) by the mobile node, and
wherein the mobile IP registration request message is transmitted to the virtual private network gateway by means of the FA.

9. The method for a mobile node's connection to a virtual private network using a mobile IP according to claim 1,
wherein the private IP address is recorded in a home IP address field of the response message.
